(19) United States
(12) Patent Application Publication
(10) Pub. No.: US 2015/0239070 A1
(43) Pub. Date: Aug. 27, 2015

(54) JOINING MATERIAL

(71) Applicant: Hitachi Metals, Ltd., Tokyo (JP)

(72) Inventors: Kazuma Kuroki, Hitachinaka (JP); Yuichi Oda, Ibaraki (JP); Hiromitsu Kuroda, Hitachi (JP)

(21) Appl. No.: 14/339,643

(22) Filed: Jul. 24, 2014

(30) Foreign Application Priority Data
Feb. 27, 2014 (JP) 2014-036371

(51) Int. Cl. B23K 35/02; B23K 35/26; B23K 35/30; B23K 35/00

(52) U.S. Cl. CPC B23K 35/0238; B23K 35/002; B23K 35/262; B23K 35/3006; B23K 35/3013; B23K 35/302

(57) ABSTRACT

A joining material includes a composite material including a first metal material having a thermal expansion coefficient of not more than 5, and a second metal material formed on the first metal material, the second metal material having a thermal expansion coefficient higher than the first metal material, and a solder material formed on the composite material. The solder material includes a lead-free solder having a melting point of not less than 260 degrees C., and a laminated structure configured such that a Zn based metal material including Zn as a main component, a first Al based metal material including Al as a main component, and a first X based metal material including Cu, Au, Ag or Sn as a main component are laminated in the order starting from the composite material.

The present application is based on Japanese patent application No. 2014-036371 filed on Feb. 27, 2014, the entire contents of which are incorporated herein by reference.

### BACKGROUND OF THE INVENTION

1. Field of the Invention

This invention relates to a joining material.

2. Description of the Related Art

A hybrid integrated circuit is disclosed in JP-H05-109919, the hybrid integrated circuit including a ceramics substrate, a wiring layer joined on the ceramics substrate, a power element disposed on the ceramics substrate, wherein the wiring layer is formed by joining a flat clad plate having a three-layered structure of Cu/Invar/Cu on the ceramics substrate with solder so that the flat clad plate is configured to function as a wire for supplying a large electric current for the power element.

In the hybrid integrated circuit, a chip terminal and a welding lead are joined by solder reflow on a solder layer formed on the flat clad plate via a Ni plated layer.

Conventionally, an element of lead (Pb) has been included in the solder that is a joint material used also in the hybrid integrated circuit described in JP-H05-109919. However, from around 2003, a movement of regulating the use of lead of which harmfulness to the human body is pointed out has spread with a focus on Europe, and development of a lead-free alternative material that does not include lead has been pursued.

A solder is divided into three groups of high temperature, middle temperature and low temperature according to the melting point. Of these, as to the high temperature solder, there was no lead-free high temperature solder that satisfies all of the market requirements of heat resistance at 260 degrees C., high thermal conductivity, joining reliability and low cost.

Consequently, the development of the lead-free high temperature solder satisfying all of the market requirements has been required, and as a developed product, there is a lead-free joint material disclosed in JP-2012-071347.

### SUMMARY OF THE INVENTION

The joint material disclosed in JP-2012-071347 is configured to be melted from an interface between Zn and Al, thus it shrinks due to surface tension before wetting on the substrate. When it shrinks, diffusion unevenness occurs, or local wetting occurs at thin part of an outermost layer comprised of Cu or the like, the thin part coming into contact with a material to be joined, and shrinkage is carried out with a focus on the above-mentioned occurrence areas, thus there has been room for improvement in that a center position of mounting position is sometimes displaced from a center position when the joint material is supplied to the material to be joined.

It is an object of the invention to provide a joining material that can prevent the position displacement from the supplying position in case of using the specific joint material.

(1) According to one embodiment of the invention, a joining material comprises:
a composite material comprising a first metal material having a thermal expansion coefficient of not more than 5, and a second metal material formed on the first metal material, the second metal material having a thermal expansion coefficient higher than the first metal material; and
a solder material formed on the composite material,
wherein the solder material comprises a lead-free solder having a melting point of not less than 260 degrees C., and a laminated structure configured such that a Zn based metal material including Zn as a main component, a first Al based metal material including Al as a main component, and a first X based metal material including Cu, Au, Ag or Sn as a main component are laminated in the order starting from the composite material.

In the above embodiment (1) of the invention, the following modifications and changes can be made.
(i) The solder material is configured such that a second Al based metal material including Al as a main component is further laminated between the composite material and the Zn based metal material.
(ii) The solder material is configured such that a second X based metal material including Cu, Au, Ag or Sn as a main component is further laminated between the composite material and the second Al based metal material.
(iii) The solder material is formed on the composite material via a plated layer of nickel (Ni), gold (Au), or silver (Ag).
(iv) The composite material has a thermal expansion coefficient of 5 to 15.
(v) The first metal material comprises one of a Fe—Ni based alloy, Mo and W, and the second metal material comprises one of Cu, Al and Ni.
(vi) The joining material is used to provide a solder joining between a first material to be joined and a second material to be joined having a thermal expansion coefficient higher than the first material to be joined.
(vii) The composite material has a thermal expansion coefficient higher than the first material to be joined, and has a thermal expansion coefficient lower than the second material to be joined.

### Effects of the Invention

According to one embodiment of the invention, a joining material can be provided that can prevent the position displacement from the supplying position in case of using the specific joint material.

### BRIEF DESCRIPTION OF THE DRAWINGS

The preferred embodiments according to the invention will be explained below referring to the drawings, wherein:

FIG. 1 is a cross-sectional view schematically showing a joining material according to one embodiment of the invention;

FIGS. 2A to 2C are cross-sectional views schematically showing a detail configuration example of the joining material shown in FIG. 1 respectively;

FIG. 3 is a cross-sectional view for explaining a manufacture procedure of the joining material according to the embodiment of the invention;

FIG. 4 is a cross-sectional view schematically showing a first application example of the joining material according to the embodiment of the invention;

FIG. 5 is a cross-sectional view schematically showing a second application example of the joining material according to the embodiment of the invention;

FIG. 6 is a cross-sectional view schematically showing a third application example of the joining material according to the embodiment of the invention; and

FIG. 7 is a cross-sectional view schematically showing a fourth application example of the joining material according to the embodiment of the invention.

### DETAILED DESCRIPTION OF THE PREFERRED EMBODIMENTS

[Configuration of Joining Material]

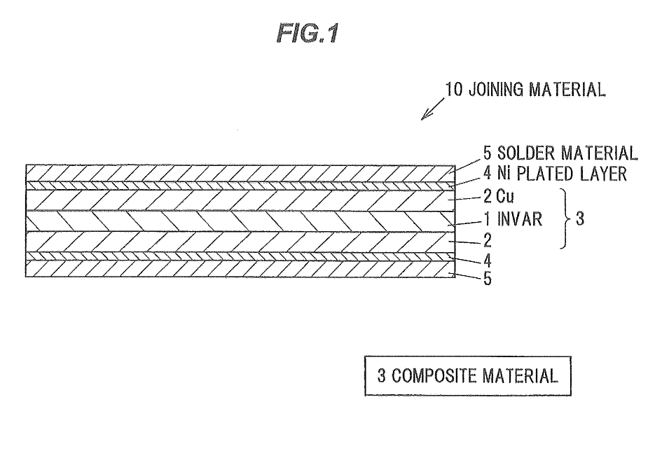

FIG. 1 is a cross-sectional view schematically showing a joining material according to one embodiment of the invention. The joining material 10 according to one embodiment of the invention includes a composite material 3 comprising a first metal material (for example, Invar 1) having a thermal expansion coefficient of not more than 5, and a second metal material (for example, Cu 2) formed on the first metal material, the second metal material having a thermal expansion coefficient higher than the first metal material, and a solder material 5 formed on the composite material 3. The solder material 5 is formed on the composite material 3 directly or via the Ni plated layer 4.

(Configuration of Composite Material 3)

The composite material 3 includes the first metal material having a thermal expansion coefficient of not more than 5, and the second metal material formed on the first metal material (both surfaces thereof), the second metal material having a thermal expansion coefficient higher than the first metal material.

As the first metal material having a thermal expansion coefficient of not more than 5, as shown in FIG. 1, it is particularly preferred to use a Fe—Ni based alloy such as Invar 1 (for example, Invar having a thermal expansion coefficient of approximately 1 to 2). Mo or W can be also used. In addition, as the second metal material having a thermal expansion coefficient higher than the first metal material, it is preferred to use any one of Cu, Al and Ni, and as shown in FIG. 1, it is particularly preferred to use Cu 2 having a thermal expansion coefficient of approximately 17.

The composite material 3 is configured to have a thermal expansion coefficient of preferably 5 to 15, and more preferably 7 to 13 by selecting a type (thermal expansion coefficient) or adjusting a thickness of the first and the second metal material. If the composite material 3 is configured to have a structure of Cu/Invar/Cu as shown in FIG. 1, the composite material 3 is configured to have a thermal expansion coefficient of preferably 9 to 11.

The first metal material has a thickness of preferably 40 to 1200 μm, more preferably 80 to 400 μm. In addition, the second metal material has a thickness of preferably 20 to 2400 μm, more preferably 40 to 800 μm. The composite material 3 has the whole thickness of preferably 100 to 3000 μm, more preferably 200 to 1000 μm. It is preferable that the thickness ratio of the second metal material/the first metal material/the second metal material is configured to be (10 to 40)/(20 to 80)/(10 to 40). For example, in case of Cu/Invar/Cu, it is preferable that the thickness ratio is configured to be 1/1/1.

(Configuration of Solder Material 5)

The solder material 5 is a lead-free solder having a melting point of not less than 260 degrees C., and has a laminated structure configured such that a Zn based metal material including Zn as a main component, a first Al based metal material including Al as a main component, and a first X based metal material including Cu, Au, Ag or Sn as a main component are laminated in the order starting from the composite material 3. It is preferable that the solder material 5 is a lead-free solder having a melting point of not less than 350 degrees C. and not more than 400 degrees C.

The solder material 5 can be also configured to have a laminated structure configured such that a second Al based metal material including Al as a main component is further laminated between the composite material 3 and the Zn based metal material, and can be also configured to have a laminated structure configured such that a second X based metal material including Cu, Au, Ag or Sn as a main component is further laminated between the composite material 3 and the second Al based metal material.

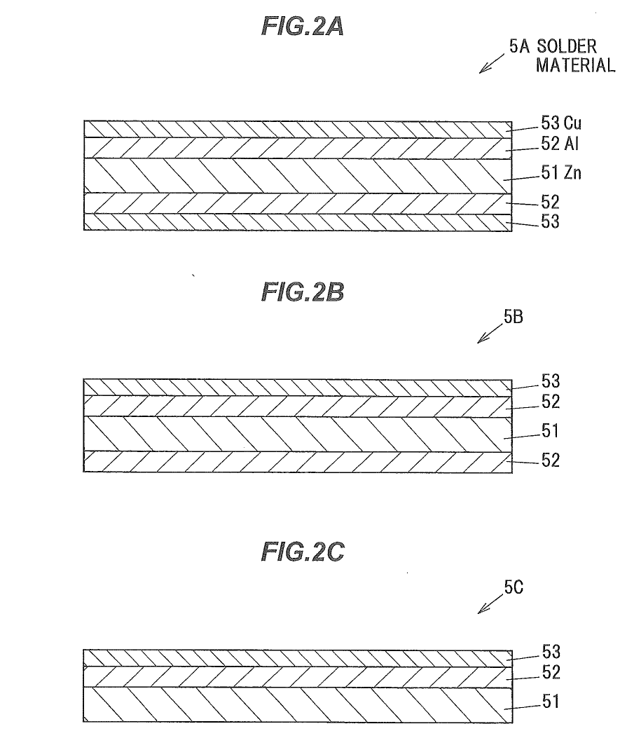

FIGS. 2A to 2C are cross-sectional views schematically showing a detail configuration example of the solder material shown in FIG. 1 respectively.

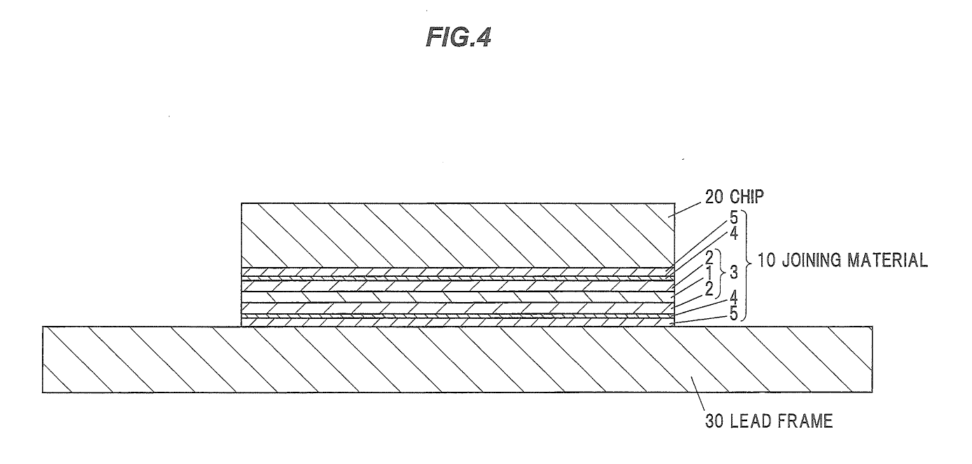

The solder material 5A having a plate-like shape shown in FIG. 2A has the same configuration as that described in FIG. 4 of the above-mentioned JP-2012-71347 A1, and as the X based metal material, Cu is exemplified. In particular, the solder material 5A is a laminated material including a Zn based metal material 51 (hereinafter, may be referred to as merely “Zn”) formed in the center thereof, an Al based metal material 52 (hereinafter, may be referred to as merely “Al”) formed on both surfaces of Zn and a Cu based metal material 53 (hereinafter, may be referred to as merely “Cu”) formed on each Al based metal material 52.

The solder material 5B having a plate-like shape shown in FIG. 2B is a laminated material configured such that the second X based metal material (such as Cu) on the side that is joined to the composite material 3 does not be laminated in the laminated structure of the solder material 5A shown in FIG. 2A.

The solder material 5C having a plate-like shape shown in FIG. 2C is a laminated material configured such that the second Al based metal material on the side that is joined to the composite material 3 does not be laminated in the laminated structure of the solder material 5B shown in FIG. 2B.

In the embodiment, the solder material 5B or the solder material 5C of the four-layer structure or the three-layer structure is more preferable than the solder material 5A of the five-layer structure.

The Zn based metal material 51 is configured to include Zn as a main component (a component included therein most, the same shall apply hereinafter), and it is preferable that the content of Zn is not less than 90% by mass. Namely, it is preferable that the Zn based metal material 51 is a single Zn, or a Zn alloy including impurities of not more than 10% by mass.

The first and second Al based metal material 52 is configured to include Al as a main component, and it is preferable that the content of Al is not less than 90% by mass. Namely, it is preferable that the first and second Al based metal material 52 is a single Al, or a Al alloy including impurities of not more than 10% by mass.

The first and second X based metal material is configured to include Cu, Au, Ag or Sn as a main component, and it is preferable that the content of Cu, Au, Ag or Sn is not less than 90% by mass. In particular, it is preferable that the first and second X based metal material is the Cu based metal material 53 shown in the drawing, including Cu as a main component and having the Cu content of not less than 90% by mass. Namely, it is preferable that the first and second X based metal material is a single Cu, or a Cu alloy including impurities of not more than 10% by mass. For example, pure copper such as oxygen-free copper, tough pitch copper, a dilute copper alloy including sulfur of 3 to 15 ppm by mass, oxygen of 2 to 30 ppm by mass and Ti of 5 to 55 ppm by mass or the like can be used.

As to the five-layer structure of X/Al/Zn/Al/X, for the purpose of generating sufficient liquid phase at the time of melting and enhancing wettability, it is preferable that the five-layer structure has the whole thickness of not less than 20 μm. In addition, in order to lower thermal resistance of the joining part and ensure reliability, it is preferable that the five-layer structure has the whole thickness of not more than 300 μm.

In case of the four-layer structure of X/Al/Zn/Al, it is preferable that the four-layer structure has the whole thickness of not less than 18 μm and not more than 299 μm. In addition, in case of the three-layer structure of X/Al/Zn, it is preferable that the three-layer structure has the whole thickness of not less than 15 μm and not more than 297 μm.

It is preferable that the ratio of (total layer thickness of Al)/(layer thickness of Zn) falls within the range of 1/60 to ⅓. In addition, for the purpose of uniformly melting the whole of the laminated material, it is preferable that the ratio of layer thickness of Al, Zn, Al (Al:Zn:A1) falls within the range of (1:6:1) to (1:60:1). Furthermore, in terms of uniformity of the melted structure, it is more preferable that the ratio (Al:Zn:A1) falls within the range of (1:8:1) to (1:30:1). In case of the three-layer structure of X/Al/Zn, it is preferable that the ratio of layer thickness of Al, Zn (Al:Zn) falls within the range of (1:3) to (1:60).

In addition, the X based metal material is needed to have a thickness of not less than a certain amount so as to have a function that is capable of preventing Zn and Al from being oxidized. On the other hand, the X based metal material results in being melted into a Zn—Al alloy produced by reaction of Zn and Al so as to be melted, and constituting a Zn—Al—Cu alloy, in this case, it is preferred to minimize an influence imparted by the element X on hardness and melting point of the Zn—Al alloy. Consequently, the X based metal material is needed to be thinner than Zn and Al. The layer thickness ratio [(Al+Zn+Al):(X+X)] is preferably [(1):(0.0002 to 0.2)] and more preferably [(1):(0.0005 to 0.1)]. In case of the three-layer structure of X/Al/Zn, it is preferable that the layer thickness ratio [(Zn+A1):(X)] is [(1):(0.0001 to 0.1)], and in case of four-layer structure of X/Al/Zn/Al, it is preferable that the layer thickness ratio [(Al+Zn+Al):(X)] is [(1):(0.0001 to 0.1)].

The solder material 5 shown in FIG. 1 is formed on both surfaces of the composite material 3 directly or via the Ni plated layer 4, but a gold or silver plated layer can be also used instead of the Ni plated layer 4. The above-mentioned plated layers are formed, thereby the joining force is enhanced. In addition, in a method of application such as application examples 2 to 4 described below, a configuration that the solder material 5 is formed on only one surface instead of both surfaces can be also adopted.

[Manufacturing Method of Joining Material]

Next, a manufacturing method of the joining material according to the embodiment will be explained.

The composite material 3 can be obtained as a clad material by holding both surfaces of the first metal material (for example, Invar 1) with the second metal materials (for example, Cu 2) so as to integrate by a cold rolling process, an extrusion process or the like.

The solder material 5 (5A to 5C) can be manufactured by a clad rolling method, a plating method, or vapor deposition method. Details thereof can be manufactured by a method described in the above-mentioned JP-2012-71347 A1, thus the explanation will be omitted. Further, the solder material 5B, 5C can be also obtained by removing the X based metal material, or the X based metal material and the Al based metal material formed on the one surface of the solder material 5A by brushing with a brush after the solder material 5A has been manufactured.

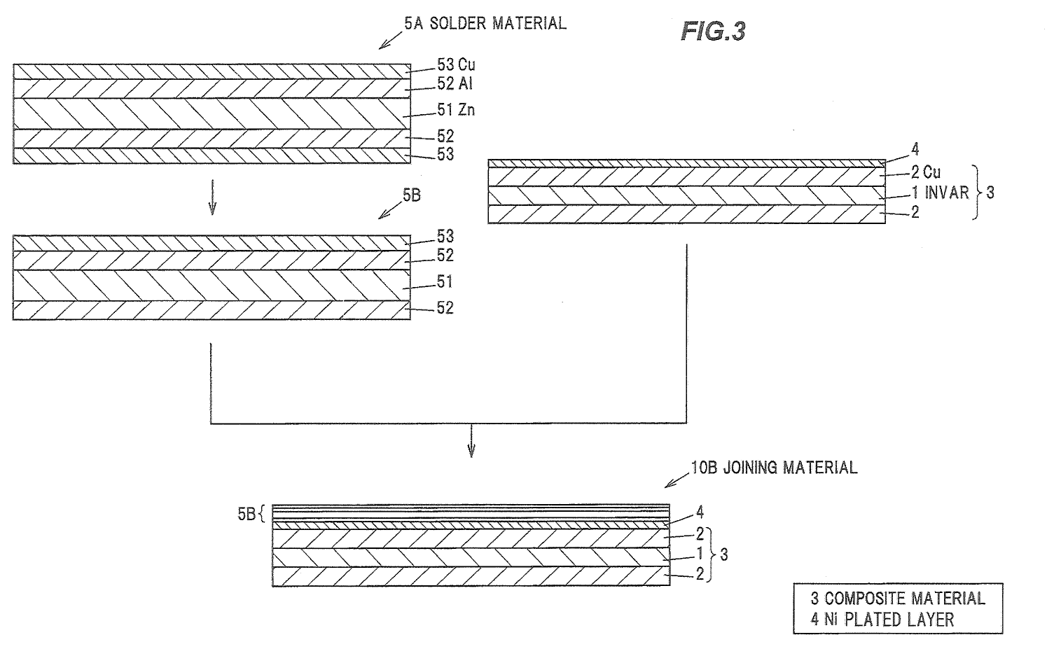

FIG. 3 is a cross-sectional view for explaining a manufacture procedure of the joining material according to the embodiment of the invention, and FIG. 3 shows an example of a manufacturing process of the joining material 10B configured to have the solder material 5B on the one surface of the composite material 3. Further, in FIG. 3, the solder material 5A, 5B described on the upper left of FIG. 3 is shown on a scale larger than its actual size in order that the configuration can be easily understood.

The Ni plated layer 4 is formed on the composite material 3 manufactured by the above-mentioned method and the solder material 5B is joined on the Ni plated layer 4 by the clad rolling method or the like, thereby the joining material 10B can be obtained. It is preferable that the joining surface of the solder material 5B with the Ni plated layer 4 is washed so as to remove foreign substance and the like on the surface by brushing with a brush or the like before joining. The same can be said about the case in which the solder material 5A, 5C is used. Consequently, it is preferable that the following solder material is used as the solder material 5B, 5C in terms of being capable of preventing oxidation until the joining and obtaining a washing effect of the joining surface, the solder material being obtained by removing the X based metal material, or the X based metal material and the Al based metal material formed on the one surface of the solder material 5A by brushing with a brush or the like after the solder material 5A has been manufactured.

### APPLICATION EXAMPLES

### First Application Example

FIG. 4 is a cross-sectional view schematically showing the first application example of the joining material according to the embodiment of the invention. Namely, the joining material 10 according to the embodiment of the invention can be preferably used as a joining material configured to perform a solder joining between a first material to be joined (a chip 20 or the like) and a second material to be joined (a lead frame 30 or the like) having a thermal expansion coefficient higher than the first material to be joined. In this case, the composite material 3 is configured to have a thermal expansion coefficient higher than the first material to be joined, and has a thermal expansion coefficient lower than the second material to be joined. For example, in case of performing the solder joining between the chip 20 (the first material to be joined) having a thermal expansion coefficient of approximately 3 and the lead frame 30 (the second material to be joined) having a thermal expansion coefficient of approximately 17 as shown in FIG. 4, it is preferable that the composite material 3 having a thermal expansion coefficient of 5 to 15 is used. It is more preferable that the composite material 3 having a thermal expansion coefficient of 7 to 13 is used. Due to this, the joining material 10 functions as a solder material providing an effect of the embodiment, and simultaneously functions as a buffer material (a stress buffer material) capable of reducing thermal stress caused by difference of thermal expansion coefficient.

### Second to Fourth Application Examples

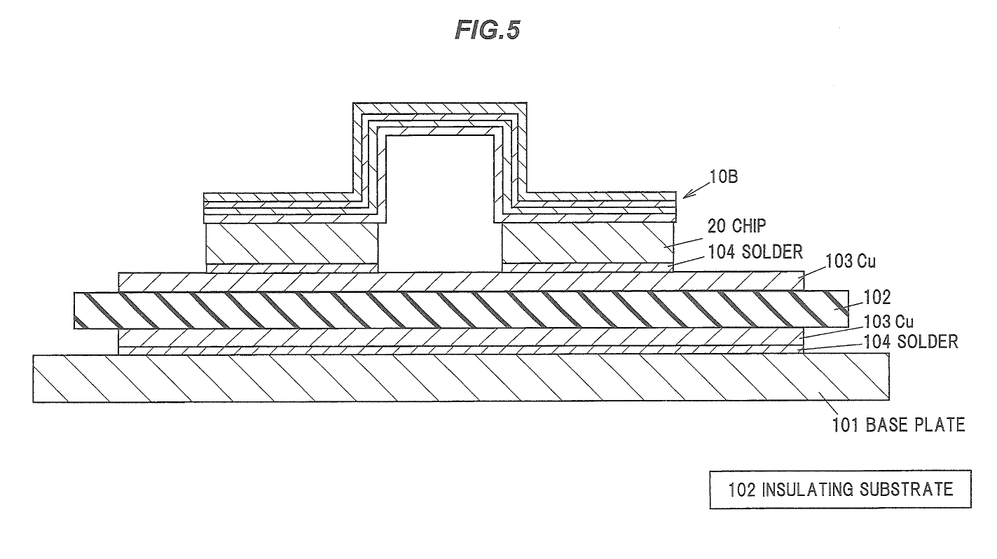

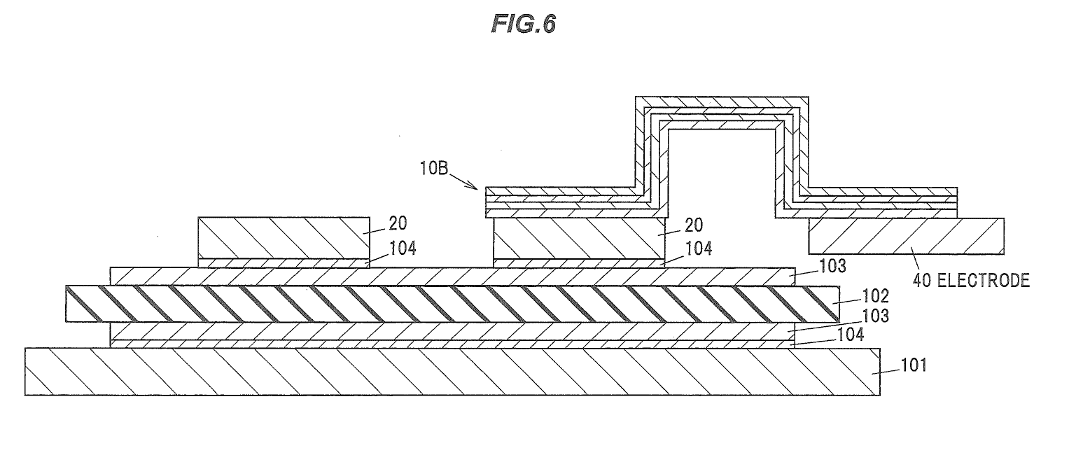

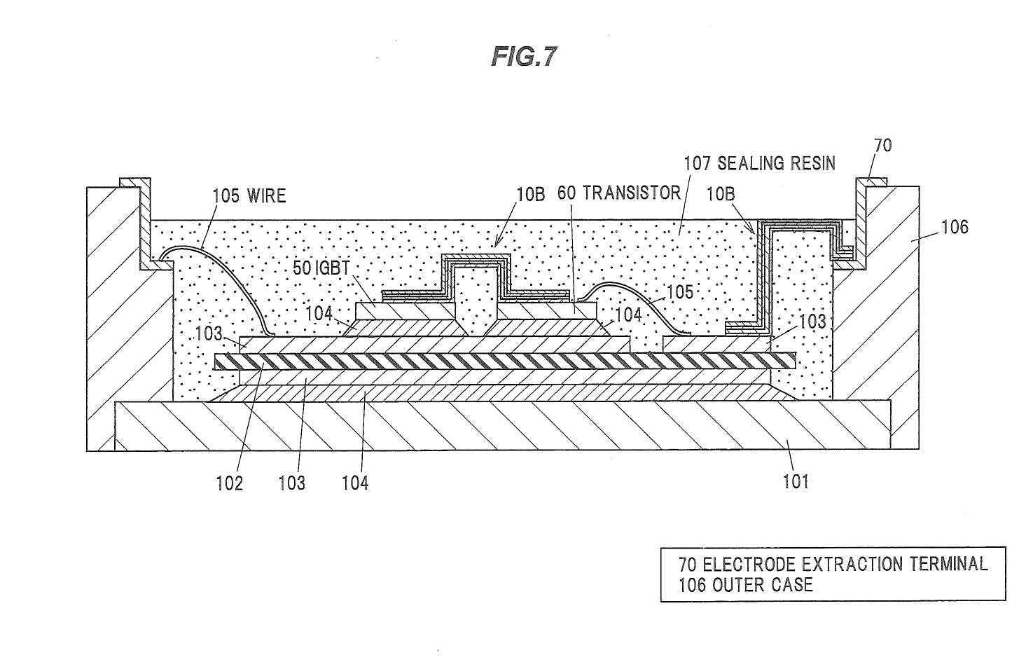

FIGS. 5 to 7 are cross-sectional views schematically showing the second to fourth application examples of the joining material according to the embodiment of the invention. The joining material according to the embodiment of the invention can be used as a lead material or the like of a semiconductor device having various structures. For example, the joining material can be used as a lead material for connection between the chip 20 and the chip 20 as shown in FIG. 5, a lead material for connection between the chip 20 and the electrode 40 as shown in FIG. 6, and a lead material for connection between the IGBT 50 and the transistor 60 as shown in FIG. 7. The wire 105 shown in FIG. 7 can be also replaced by the joining material according to the embodiment of the invention.

### Effect of the Embodiment

According to the embodiment of the invention, in case of using a specific joint material, namely in case of using a joint material having a laminated structure configured such that a Zn based metal material including Zn as a main component, an Al based metal material including Al as a main component, and an X based metal material including Cu, Au, Ag or Sn as a main component are laminated, the composite material 3 is located as the upper layer of the solder material 5 of the specific joint material, thus even if it becomes locally wet at the time of melting, it does not shrink, consequently a joining material can be provided that is capable of preventing position displacement from the supplying position. In addition, the composite material 3 and the solder material 5 are integrally formed preliminarily, thus there is a merit of process omission, consequently a joining material can be provided that is capable of dispensing with a solder paste.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

For example, the joining material according to the embodiment of the invention can be formed in various shapes such as a plate-like shape, a linear shape of which cross section is circular, elliptical or rectangular shape.

What is claimed is:

1. A joining material, comprising:
a composite material comprising a first metal material having a thermal expansion coefficient of not more than 5, and a second metal material formed on the first metal material, the second metal material having a thermal expansion coefficient higher than the first metal material; and
a solder material formed on the composite material,
wherein the solder material comprises a lead-free solder having a melting point of not less than 260 degrees C., and a laminated structure configured such that a Zn based metal material including Zn as a main component, a first Al based metal material including Al as a main component, and a first X based metal material including Cu, Au, Ag or Sn as a main component are laminated in the order starting from the composite material.

2. The joining material according to claim 1, wherein the solder material is configured such that a second Al based metal material including Al as a main component is further laminated between the composite material and the Zn based metal material.

3. The joining material according to claim 2, wherein the solder material is configured such that a second X based metal material including Cu, Au, Ag or Sn as a main component is further laminated between the composite material and the second Al based metal material.

4. The joining material according to claim 1, wherein the solder material is formed on the composite material via a plated layer of nickel (Ni), gold (Au), or silver (Ag).

5. The joining material according to claim 1, wherein the composite material has a thermal expansion coefficient of 5 to 15.

6. The joining material according to claim 1, wherein the first metal material comprises one of a Fe—Ni based alloy, Mo and W, and the second metal material comprises one of Cu, Al and Ni.

7. The joining material according to claim 1, wherein the joining material is used to provide a solder joining between a first material to be joined and a second material to be joined having a thermal expansion coefficient higher than the first material to be joined.

8. The joining material according to claim 7, wherein the composite material has a thermal expansion coefficient higher than the first material to be joined, and has a thermal expansion coefficient lower than the second material to be joined.
